(19) United States
(12) Patent Application Publication
(10) Pub. No.: US 2018/0361811 A1
(43) Pub. Date: Dec. 20, 2018

(54) Suspension Assembly

(71) Applicant: HENDRICKSON USA, L.L.C., Itasca, IL (US)

(72) Inventors: Bun-Hiong Chua, Naperville, IL (US); Hormoz KERENDIAN, Buffalo Grive, IL (US); Ashley DUDDING, Yorkville, IL (US); Antonio GONNELLA, Chicago, IL (US)

(21) Appl. No.: 15/780,096

(22) PCT Filed: Nov. 30, 2016
(86) PCT No.: PCT/US16/64180

§ 371 Date: May 30, 2018

Related U.S. Application Data
(60) Provisional application No. 62/261,022, filed on Nov. 30, 2015.
(60) Provisional application No. 62/395,078, filed on Sep. 15, 2016.

(30) Foreign Application Priority Data
May 19, 2016 (CN) 201610334798.2

(51) Int. Cl. B60G 7/02; B60G 9/00; B60G 13/00

(52) U.S. Cl. CPC B60G 7/02; B60G 9/003; B60G 13/003; B60G 2200/31; B60G 2300/026; B60G 2204/143; B60G 2204/41; B60G 2204/4302; B60G 2206/601; B60G 2204/128

(57) ABSTRACT

A frame hanger bracket for pivotally mounting a suspension main support member to a vehicle frame features a pair of ear portions adapted to be attached to the vehicle frame. A bridge portion is positioned between the pair of ear portions and a pair of flanges extending from the bridge portion so that a space is defined that receives the proximal end of a vehicle main support member. Each of the pair of flanges includes a positioning member including a space that receives an end portion of a pivot fastener attacked to the main support member so that a double shear connection is formed with the pivot fastener. The bottom end of a shock absorber is pivotally connected to a distal end of the main support member while the upper end is pivotally connected to an outboard upper shock bracket. The shock bracket may be mounted to the vehicle frame with the ear portion of the frame hanger bracket sandwiched between the shock bracket and the vehicle frame rail. A casting may be machined to create such a mid bracket, or alternatively machined to make a rear shock bracket that connects directly to the vehicle frame.

### RELATED APPLICATIONS

This application claims the benefit of and priority of U.S. Provisional Patent Application Ser. No. 62/261,022, filed Nov. 30, 2015, Chinese Non-provisional Patent Application No. 201610334798.2, filed May 19, 2016, and U.S. Provisional Patent Application No. 62/395,078, filed Sep. 15, 2016, the contents of which are incorporated by reference herein.

### FIELD OF THE INVENTION

The present disclosure relates generally to vehicle suspension systems and, in particular, to assemblies used to connect vehicle suspension components to a vehicle frame.

### BACKGROUND

Trailing-arm suspensions are used in a variety of vehicle applications and feature a variety of designs and configurations. Regardless of the application, however, a trailing arm suspension typically features a main support member pivotally attached at the leading or proximal end by a frame hanger assembly. A vehicle axle is typically clamped or otherwise secured to a middle portion of the main support member, and the trailing or distal end of the main support member is attached to the vehicle frame via a shackle, an air spring mechanism or some other arrangement.

In many trailing-arm suspensions, the main support member takes the form of a leaf spring having an eye formed at the leading end. A frame hanger bracket is attached to the vehicle frame, typically by welding or fasteners, such as nuts and bolts. A bar pin and surrounding elastomeric bushing are typically positioned within the eye of the leaf spring leading end with ends of the bar pin extending horizontally out of opposite sides of the bushing and leaf spring eye. The exposed bar pin ends typically feature openings which receive fasteners such as bolts or the like that attach the bar pin ends to the frame hanger bracket.

The vehicle axle must be properly aligned with the vehicle frame for the vehicle to track properly and to minimize wear to the vehicle tires and suspension components. Truing the alignment of the axle to the frame is often accomplished by way of the frame hanger assembly by using shims or plates.

An example of a frame hanger that uses shims for alignment is provided in U.S. Patent Application Publication No. US 2006/0103103 to Land et al. In Land et al., bar pin ends that pass through the main support member eye and bushing are bolted to a frame hanger. Shims may be inserted between the bar pin ends and the frame hanger to adjust alignment of the main support members, and thus the vehicle axle. Each bar pin end of Land et al., however, is engaged by the frame hanger, or shims positioned between the bar pin end and frame hanger, on a single side. While this type of arrangement performs well and is popular, it provides a single shear attachment for the bar pin which reduces the strength of the connection which may be unacceptable for some heavy duty applications.

An alternative frame hanger assembly that uses shims for alignment is presented in U.S. Pat. No. 7,513,517 to Barton et al. Barton et al. discloses a design that is similar to Land et al., however, the bar pin ends are each positioned between, and secured to, forward and rearward flange tabs of the frame hanger. Shims are then positioned between each bar pin end and the forward and/or rearward flange tabs for alignment purposes. The frame hanger of Barton et al., however, must be welded to the vehicle frame. In addition, the ability to align the vehicle axle after the frame hanger is welded in position is limited to the spacing between the forward and rearward flange tabs minus the space occupied by each bar pin end. If a different spacing between the forward and rearward flange tabs is desired, which may be required for different applications, an entirely new frame hanger must be manufactured and provided. The frame hanger of Barton et al. cannot be machined or otherwise finished to provide an alternative spacing for axle alignment purposes.

An example of a frame hanger assembly that accomplishes axle alignment without the use of shims is the QUICK-ALIGN system offered by Hendrickson USA, LLC of Itasca, Ill. This system uses eccentric and concentric collars to position a bolt, which passes through a bushing positioned in the eye of the main support member, with respect to the frame hanger. While this system functions well and is very popular, the connection has strict torque requirements which must be met during installation and maintenance.

In addition, truck manufacturers offer a variety of pre-formed bolt opening patterns in the frames to which the suspension frame hangers are to be attached. In other words, the bolt opening patterns in truck frames vary by manufacturer. A frame hanger must feature a mounting bolt hole configuration that matches the manufacturer's frame hole pattern for the frame hanger to be easily installed. This typically requires frame hangers that are individually designed and manufactured to fit a particular manufacturer's truck. It is desirable to provide a single frame hanger design that may be machined or otherwise finished so as to fit a variety of truck frame bolt hole patterns.

A suspension assembly that addresses at least some of the above issues is desirable.

### BRIEF DESCRIPTION OF THE DRAWINGS

FIG. 1 is a perspective view of a portion of a vehicle frame and a suspension system including an embodiment of the frame hanger assembly of the present disclosure;

FIG. 2 is a left side elevational view of the frame and suspension of FIG. 1;

FIG. 3 is an enlarged perspective view of the outer side of the frame hanger assembly of FIGS. 1 and 2;

FIG. 4 is a perspective view of the inner side of the frame hanger assembly of FIG. 3;

FIG. 5 is an enlarged inner side perspective view of the frame hanger of FIGS. 3 and 4;

FIG. 6 is a perspective view of a frame hanger casting prior to being machined to create the frame hanger of FIGS. 1-5;

FIGS. 7A and 7B are elevational views of the outer side of the frame hanger casting of FIG. 6 after being machined for use in applications that require alternative vehicle axle positions;

FIG. 8 is an enlarged perspective view of the bushing and bar pin of the frame hanger assembly of FIGS. 1-4;

FIG. 9 is a top plan view of the bushing and bar pin of FIG. 8;

FIG. 10 is a cross sectional view of the bushing and bar pin of FIGS. 8 and 9 taken along lines 10-10 of FIGS. 9 and 11;

FIG. 11 is a side perspective view of the bushing and bar pin of FIGS. 8-10;

FIG. 12 is a perspective view of the inner bushing assembly and bar pin of FIGS. 8-11;

FIG. 13 is a top plan view of the inner bushing assembly and bar pin of FIG. 12;

FIG. 14 is a cross sectional view of the inner bushing assembly and bar pin of FIGS. 12 and 13 taken along lines 14-14 of FIGS. 13 and 15;

FIG. 15 is a side perspective view of the inner bushing assembly and bar pin of FIGS. 12-14;

FIG. 16 is a rear perspective view of a portion of the frame and suspension of FIGS. 1 and 2;

FIG. 17 is a cross-sectional view of the trailing end of the main support member, the cross channel and the cross channel reinforcement plate taken along line 17-17 of FIG. 16;

FIG. 18 is a bottom perspective view of the trailing ends of the main support members and the cross channel reinforcement plate of FIGS. 16 and 17;

FIG. 19 is an outer side perspective view of an alternative embodiment of the frame hanger assembly of the present disclosure;

FIG. 20 is inner side perspective view of the frame hanger of FIG. 19;

FIG. 21 is a perspective view of a frame hanger casting prior to being machined to create the frame hanger of FIGS. 19 and 20;

FIG. 22 is a left side elevational view of a portion of a vehicle frame and a suspension assembly including embodiments of the frame hanger assembly and outboard upper shock absorber mounting brackets of the present disclosure;

FIG. 23 is an enlarged perspective view of the outer side of the mid bracket of FIG. 22;

FIG. 24 is a perspective view of the inner side of the mid bracket of FIG. 23;

FIG. 25 is a front perspective view of an assembly including the mid bracket and a frame hanger bracket attached to a portion of the vehicle frame, with the upper end of a shock absorber attached to the mid bracket and a bar pin mounted within the frame hanger bracket;

FIG. 26 is a top and rear perspective view of the assembly of FIG. 25;

FIG. 27 is a perspective view of the inner side of the mid bracket with a mounting bolt installed;

FIG. 28 is an enlarged perspective view of the outer side of the rear bracket of FIG. 22;

FIG. 29 is a perspective view of the inner side of the rear bracket of FIG. 28;

FIG. 30 is a front perspective view of an assembly including the rear bracket attached to a portion of the vehicle frame, with the upper end of a shock absorber attached to the rear bracket;

FIG. 31 is a rear perspective view of the assembly of FIG. 30;

FIG. 32 is a perspective view of the inner side of the rear bracket with a mounting bolt installed;

FIG. 33 is a perspective view of the outer side of a casting that may be used to make either the mid bracket of FIGS. 23 and 24 or the rear bracket of FIGS. 28 and 29;

FIG. 34 is a cross sectional view of the casting of FIG. 33 taken along line 34-34 of FIG. 33.

### SUMMARY OF THE DISCLOSURE

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a frame hanger bracket for pivotally mounting a suspension main support member to a vehicle frame includes a pair of ear portions adapted to be attached to the vehicle frame with a bridge portion positioned between the pair of ear portions. A pair of flanges extends from the bridge portion so that a space is defined and adapted to receive a proximal end of the main support member. Each of the pair of flanges includes an elongated positioning member including a space adapted to receive an end portion of a pivot fastener attached to the main support member so that a double shear connection is formed with the pivot fastener.

In another aspect, a frame hanger assembly for pivotally mounting a suspension main support member having an eye portion on a proximal end to a vehicle frame includes a frame hanger bracket having a pair of ear portions adapted to be fastened to the vehicle frame with a bridge portion positioned between the pair of ear portions. A pair of flanges extends from the bridge portion so that a space is defined and adapted to receive the proximal end of the main support member. Each of the pair of flanges includes a positioning member including a gap. A bushing is positioned within the eye portion of the main support member and includes a central opening. A pivot fastener passes through the central opening of the bushing and has a pair of opposite end portions positioned within the gaps of the positioning members of the pair of flanges so that a double shear connection is formed with the pivot fastener.

In another aspect, a suspension for a vehicle having a pair of frame rails includes, on each side of the vehicle, a main support member including an eye portion positioned on a proximal end and a frame hanger bracket. The frame hanger bracket includes a pair of ear portions adapted to be fastened to a corresponding one of the pair of vehicle frame rails, a bridge portion positioned between the pair of ear portions and a pair of flanges extending from the bridge portion so that a space is defined that receives the proximal end of the main support member. Each of the pair of flanges includes a positioning member including a gap. A bushing is positioned within the eye portion of the main support member and includes a central opening. A pivot fastener passes through the central opening of the bushing and has a pair of opposite end portions positioned within the gaps of the positioning members of the pair of flanges so that a double shear connection is formed with the pivot fastener.

In another aspect, a casting for forming a frame hanger bracket for pivotally mounting a suspension main support member to a vehicle frame includes a pair of ear portions adapted to have openings formed therein for attachment to the vehicle frame and a bridge portion positioned between the pair of ear portions. A pair of flanges extends from the bridge portion so that a space is defined and adapted to receive a proximal end of the main support member. Each of the pair of flanges includes a positioning member adapted to be cut to form a space for receiving an end portion of a pivot fastener attached to the main support member so that a double shear connection is formed with the pivot fastener.

In another aspect, a shock bracket for mounting an upper end of a shock absorber to a vehicle frame includes a head adapted to be secured to the upper end of the shock absorber and a mounting flange extending from the head. The mounting flange is adapted to be secured to the vehicle frame so that an inner surface of the head is spaced from the vehicle frame when the shock bracket is mounted to the vehicle frame.

In another aspect, a suspension for a vehicle having a pair of frame rails includes, on each side of the vehicle, a main support member including a proximal end and a distal end with an eye portion positioned on a proximal end. A frame hanger bracket features an ear portion adapted to be mounted to an outer surface of a frame rail of the vehicle. A pivot fastener passes through the central opening of the bushing and has a pair of opposite end portions secured within the frame hanger bracket. A shock bracket includes a head and a mounting flange, with the mounting flange adapted to be mounted to the frame rail of the vehicle with the ear portion of the frame hanger sandwiched between the shock bracket mounting flange and the outer surface of the vehicle frame rail. A shock absorber has an upper end pivotally connected to the head of the shock bracket and a lower end pivotally connected to the distal end of the main support member.

In another aspect, a casting for forming a shock bracket for pivotally mounting an upper end of a shock absorber to a vehicle frame includes a head having an inner surface and an outer surface. The head is adapted to have an opening formed therein for attachment to the upper end of the shock absorber. A mounting flange extends from the head and includes a middle portion having a first thickness and a proximal end portion having a second thickness. The first thickness is greater than the second thickness so that the mounting flange has an outer surface with a stair step profile. A backing portion protrudes beyond the inner surface of the head in a direction perpendicular to the inner surface of the head.

### DETAILED DESCRIPTION OF EMBODIMENTS

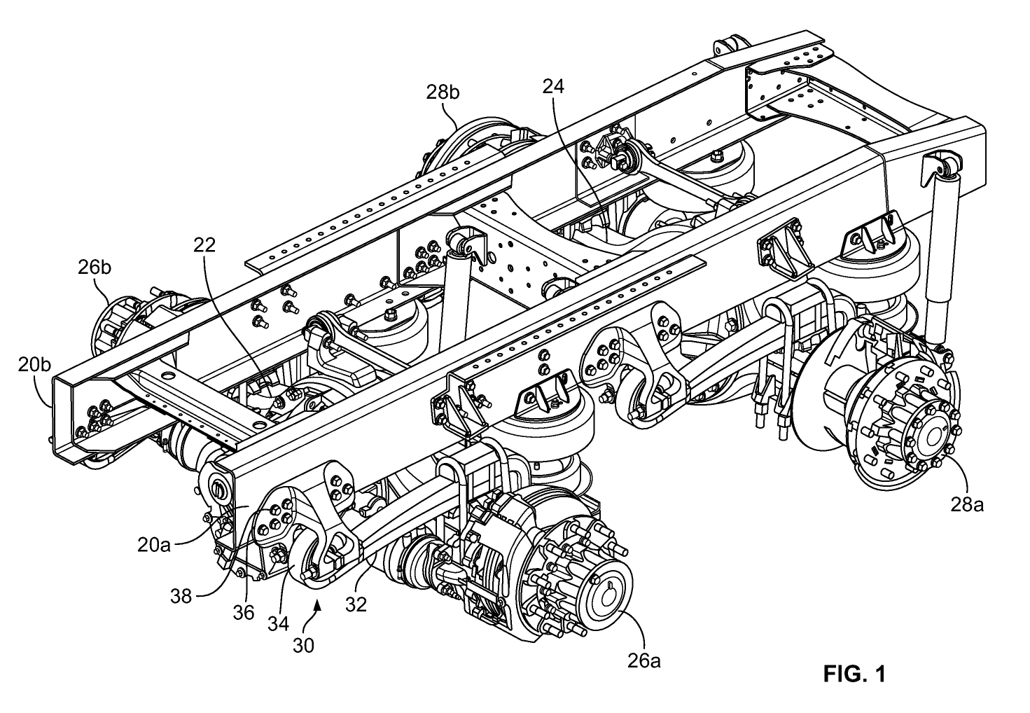

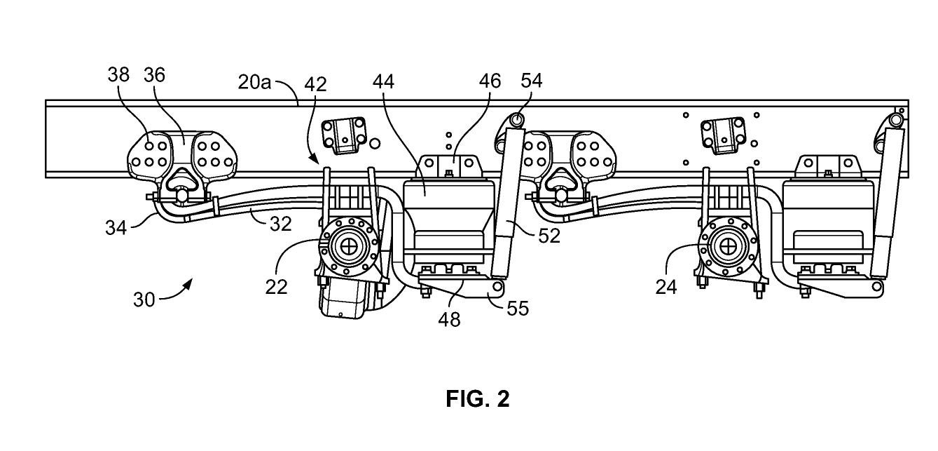

With reference to FIGS. 1 and 2, conventional components included within vehicles, such as commercial vehicles, include a pair of C-shaped longitudinally extending frame rails 20a and 20b and laterally extending axles 22 and 24, which include hubs 26a, 26b, 28a and 28b to which are mounted wheels and tires.

A suspension system incorporating an embodiment of the frame hanger assembly of the present disclosure, indicated in general at 30, mounts one end portion of axle 22 to frame rail 20a. It is to be understood that similar suspension systems mount the other end portion of axle 22 to frame rail 20b and axle 24 to frame rails 20a and 20b.

As illustrated in FIG. 1, the suspension system 30 includes a main support member in the form of a generally Z-shaped leaf spring 32. The main support member is provided with a cylindrical eye portion 34 integrally formed at the proximal end thereof. The eye portion 34 is pivotally connected to a frame hanger bracket 36, as will be described in greater detail below, which is secured to frame rail 20a by bolts 38.

Axle 22 and leaf spring 32 are connected together by axle clamp assembly components well known in the art and generally designated at 42. An air spring 44 is further included and is attached at its upper side to an air spring bracket 46 mounted to frame rail 20a. At its lower side, air spring 44 is seated on a cross channel 48 positioned on the distal end of the main support member 32. A shock absorber 52 is pivotally connected at its upper end to a bracket 54 mounted on frame rail 20a and is attached at its bottom end to a lower shock bracket 55 positioned on the trailing end of the main support member 32.

It will be apparent to those skilled in the art that while a particular suspension system is illustrated in FIGS. 1 and 2, the principles of the present invention apply to a wide variety of trailing arm suspension systems. In addition, while a tandem axle suspension is illustrated, the frame hanger assembly may be used in single axle applications or applications using a greater number of axles.

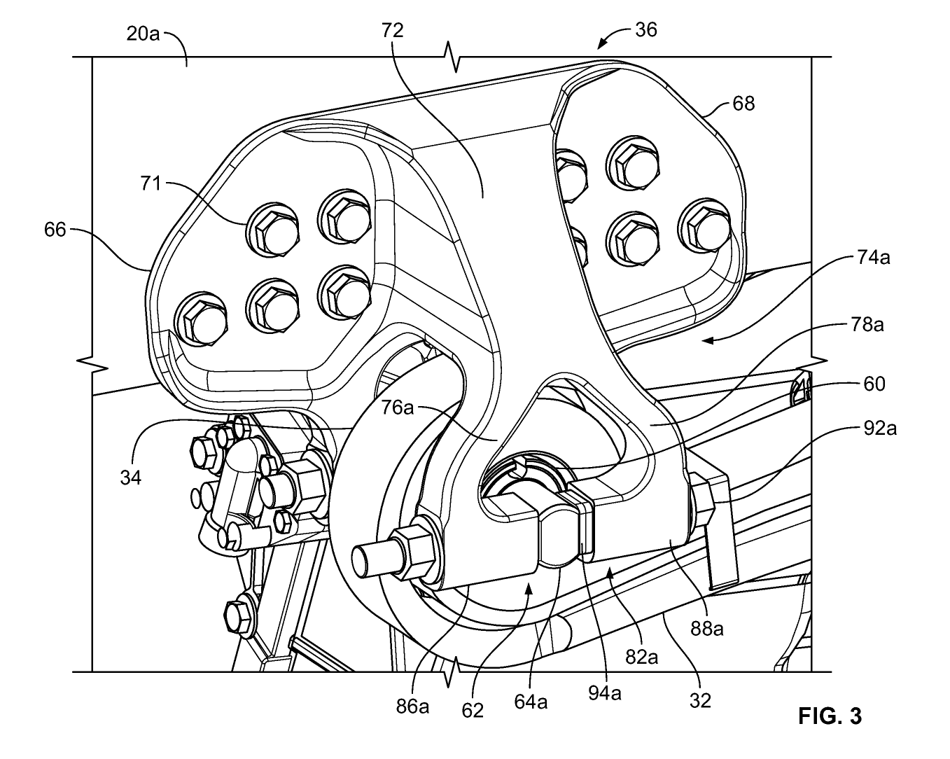

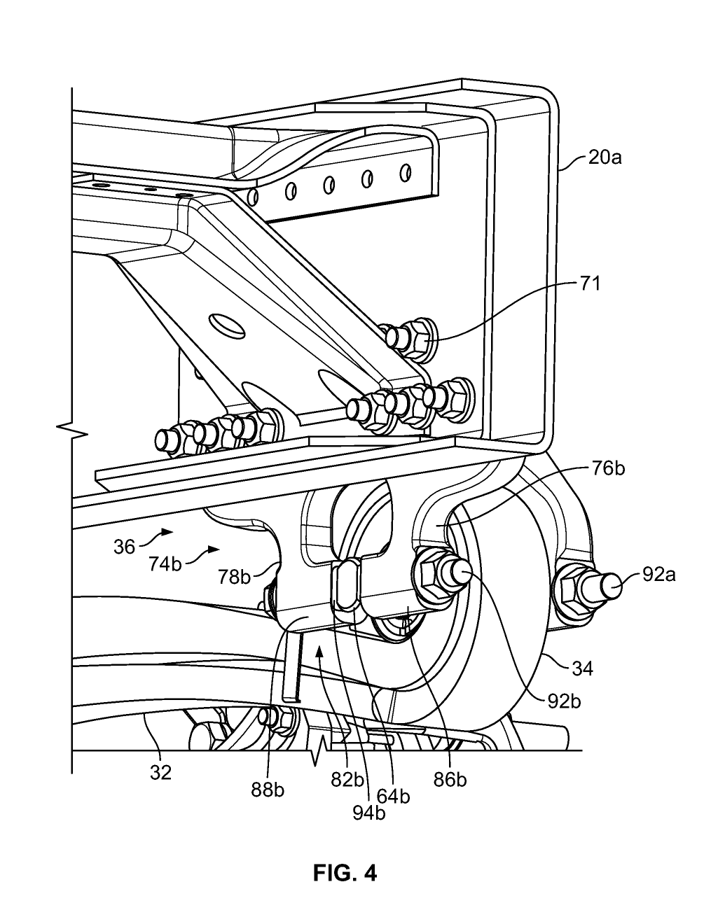

With reference to FIGS. 3 and 4, and as noted previously, the proximal end portion of the main support member 32 has a cylindrical eye portion 34. A bushing 60 and bar pin, indicated in general at 62 in FIG. 3, are positioned in the eye portion of the main support member with the bar pin ends 64a and 64b connected to frame rail 20a by a frame hanger assembly as will now be described in greater detail. It is to be understood that the remaining main support members of FIGS. 1 and 2 are attached to the corresponding frame rails in the same manner

The frame hanger assembly includes a frame hanger bracket, indicated in general at 36 in FIGS. 3-5. The frame hanger bracket includes a pair of generally flat ear portions 66 and 68 which feature openings 70 (FIG. 5) through which bolts 71 or other frame fasteners pass to secure the frame hanger bracket to the frame 20a. A bridge portion 72, which may be provided in the form of a hollow protrusion (backside illustrated in FIG. 5), is positioned between the ear portions 66 and 68 and is provided with a pair of horizontally spaced, downward extending flange portions indicated in general at 74a and 74b. Flange portion 74a is preferably formed by struts 76a and 78a, while flange portion 74b is similarly and preferably formed by struts 76b and 78b. As shown in FIG. 3, an outer bar pin elongated positioning member, indicated in general at 82a, features portions 86a and 88a joined to the distal ends of struts 76a and 78a, respectively. As shown in FIG. 4, an inner bar pin elongated positioning member, indicated in general at 82b, features portions 86b and 88b joined to the distal ends of struts 76b and 78b, respectively. The elongated positioning members preferably extend in a longitudinal direction parallel to the vehicle frame rails.

Portions 86a and 88a of the bar pin elongated positioning member 82a feature bores there through (90a in FIG. 5). As shown in FIG. 3, bar pin end 64a is positioned within the gap or space formed between portions 86a and 88b with a nut and bolt 92a passing through the bar pin positioning member bores and a corresponding opening in the bar pin end 64a (107a in FIGS. 9 and 10). Of course other fasteners known in the art may be used in place of the nut and bolt 92a as the positioning fastener. One or more shims 94a may be positioned between the bar pin end 64a and bar pin elongated positioning member portion 86a and/or 88a to align the vehicle axle with the frame.

With reference to FIG. 4, portions 86b and 88b of the bar pin elongated positioning member 82b also feature bores (90b in FIG. 5) there through. As shown in FIG. 4, bar pin end 64b is positioned within the gap or space formed between portions 86b and 88b with a nut and bolt 92b passing through the bar pin positioning member bores and a corresponding opening in the bar pin end 64b (107b in FIGS. 9 and 10). Of course other fasteners known in the art may be used in place of the nut and bolt 92b as the positioning fastener. One or more shims 94b may be positioned between the bar pin end 64b and bar pin elongated positioning member portion 86b and/or 88b to align the vehicle axle with the frame.

It is to be understood that an alternative type of pivot fastener may be used in place of bar pin 62.

In view of the above, the bar pin ends 64a and 64b are supported on each side by the frame hanger bracket 36 so as to provide a double shear bar pin pivot.

With reference to FIG. 6, frame hanger bracket 36 is preferably cast from ductile iron without openings formed in ear portions 66a and 66b and with bar pin positioning members 82a and 82b formed as a single structure. While ductile iron is easy to cast and machine, it should be noted that any material that is capable of being cast and machined may be used to construct the frame hanger bracket 36. The frame hanger bracket could alternatively be constructed from separate components that are joined together after being formed.

After the casting of FIG. 6 is created, the part is machined to form the frame hanger bracket 36 of FIGS. 3-5. More specifically, the positions of the openings 70 (FIG. 5) on ear portions 66 and 68 of the frame hanger bracket are selected and machined based on the frame hole grid or pattern chosen by the vehicle manufacturer for attaching the frame hanger brackets. This permits the single casting of FIG. 6 to be used with a variety of vehicle frames.

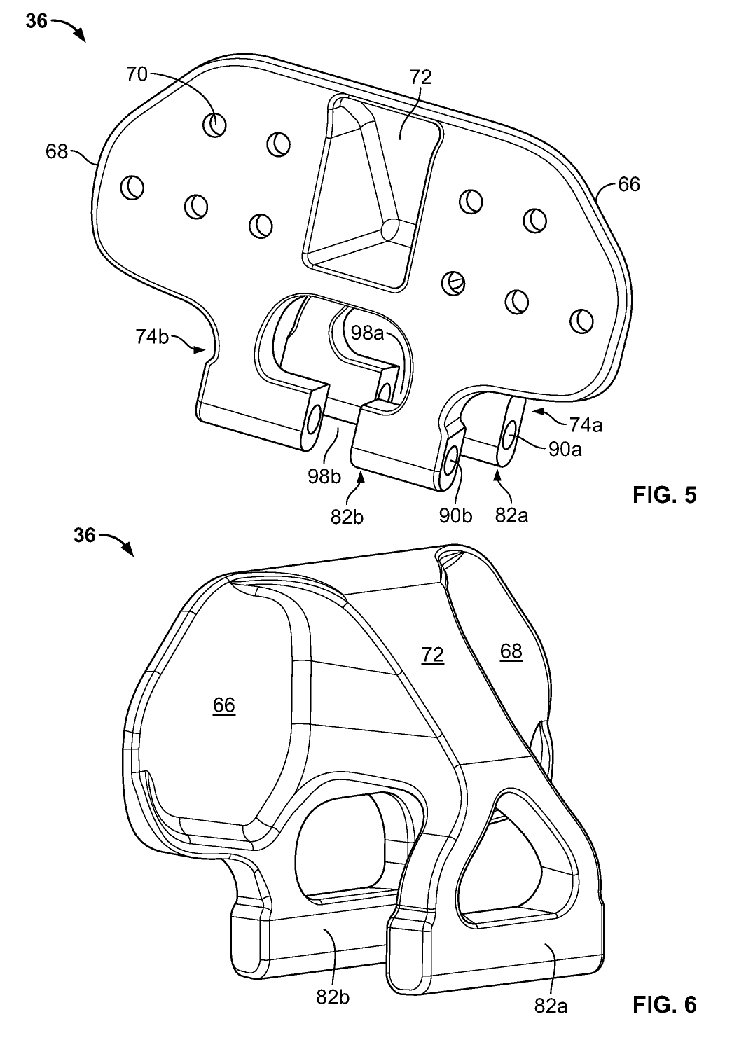

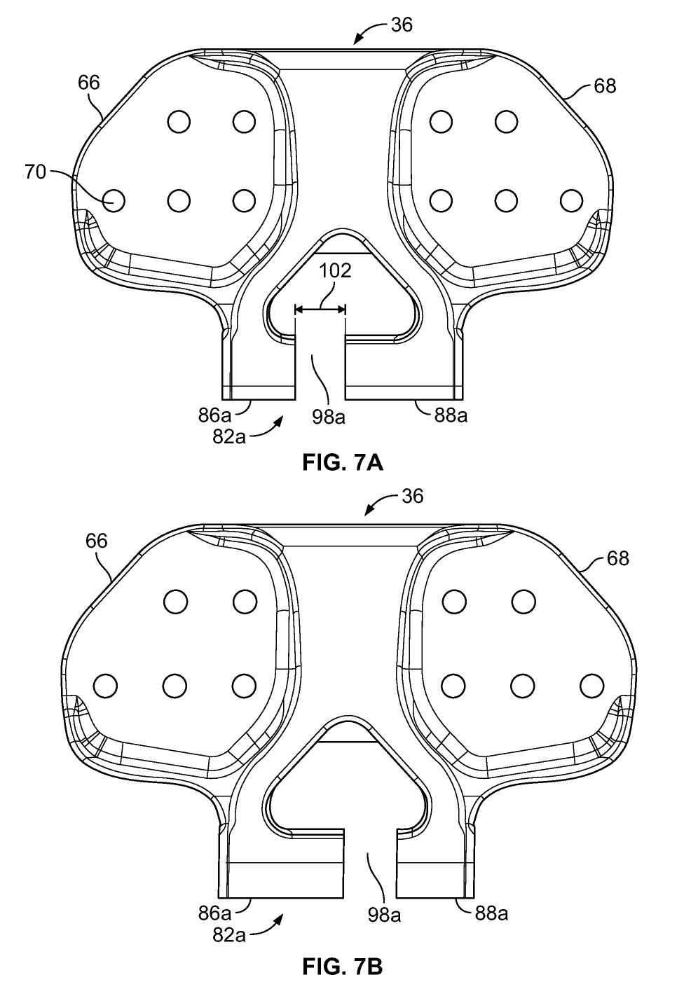

In addition, the bar pin positioning members 82a and 82b of the casting of FIG. 6 are cut so that sections may be removed to form gaps or spaces, illustrated at 98a and 98b in FIG. 5, for receiving the ends of the bar pin, or other pivot fastener passing through the main support member eye portion, and alignment adjusting shims (as illustrated in FIGS. 1-4). As shown in FIGS. 7A and 7B, the location of the spaces 98a and 98b in the bar pin positioning members 82a and 82b may be selected based upon the requirements of the vehicle manufacturer or application. Furthermore, the horizontal width of each gap (illustrated at 102 in FIG. 7A for gap 98a, with gap 98b of FIG. 5 having a similar dimension) may be selected based on the degree of axle adjustability desired, i.e., the wider the gap, the more shims that may be added on either side of the bar pin ends.

In addition machining the openings 70 in the ear portions of the frame hanger bracket so that they match a manufacturer's frame hole grid, the location of the overall group of openings 70 on each ear portion may be selected based on the needs of the vehicle or application. For example, the group of openings 70 may be machined more towards the top of the ear portion if the frame hanger bracket is to be positioned lower with respect to the vehicle frame rail, or more towards the bottom of the ear portion if the frame hanger bracket is to be positioned higher with respect to the frame rail. The group of openings also may be shifted forward or rearward on each ear portion. This provides the casting of FIG. 6 with even more flexibility with regard to accommodating various axle position requirements.

The symmetrical design of the casting of FIG. 6 also permits the part to be used on either side of the vehicle.

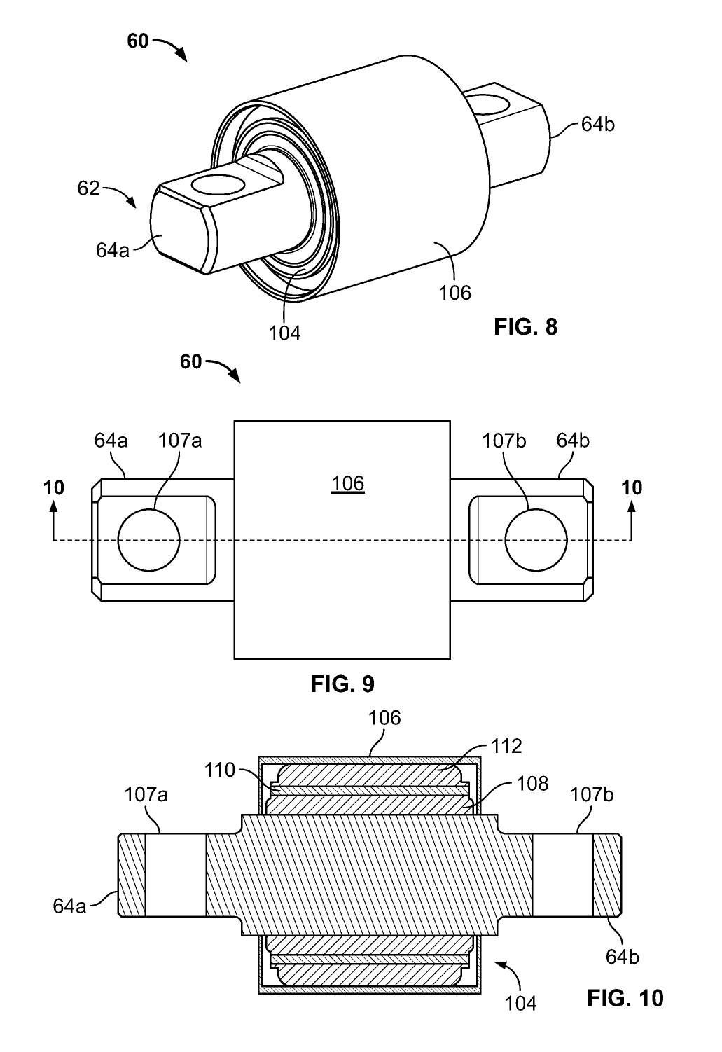

As mentioned previously, and with reference to FIGS. 3 and 8, a bushing or bushing assembly 60 is positioned within the eye portion 34 of the main support member 32 and receives a bar pin 62. An enlarged perspective view of the bushing and the bar pin, indicated in general at 60 and 62, respectively, is provided in FIG. 8. The bushing is a canned rate ring bushing and features an inner bushing assembly, indicated at 104 in FIG. 8, and an outer shell or can, indicated at 106. The can 106 is constructed from steel, metal or any other material that is at least semi-rigid. As shown in FIGS. 8-10, the bar pin includes end portions 64a and 64b, which are provided with openings 107a and 107b, which are engaged by fasteners passing through the frame hanger bracket, as described above.

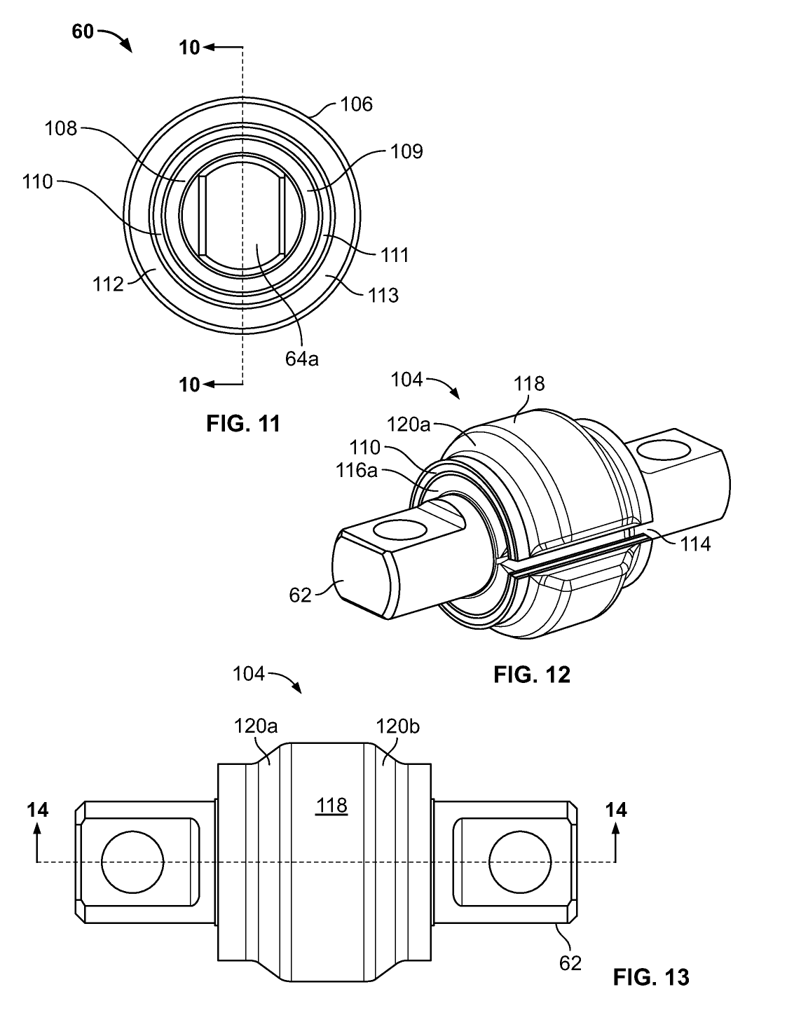

The inner bushing assembly 104 is shown in a compressed condition in FIGS. 8-11 as it is contained within can or shell 106. As shown in FIGS. 10 and 11, the inner bushing assembly 104 includes an inner elastomeric split ring including halves 108 and 109 that, when radially compressed together by the shell or can 106, form an opening which receives the bar pin. A pair of metal C-shaped half sleeves or half cylinders 110 and 111 are compressed together by shell or can 106 so as to surround the inner elastomeric split ring. An outer elastomeric split ring including halves 112 and 113 is similarly radially compressed by the shell or can 106 so as to surround the C-shaped sleeves or half cylinders 110 and 111.

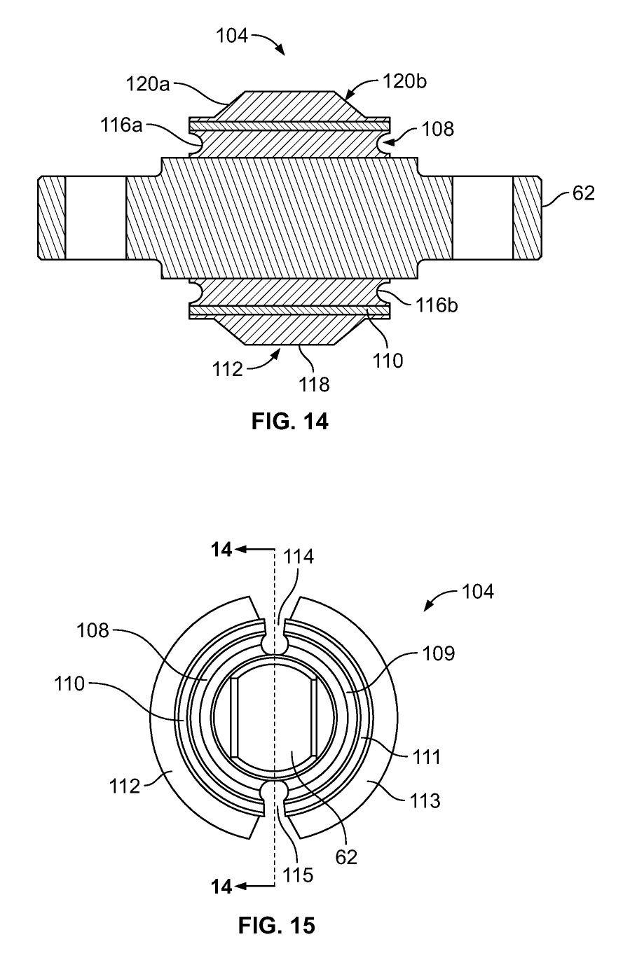

The inner bushing assembly is indicated in general at 104 and shown in the uncompressed condition (i.e. shell or can 106 of FIGS. 8-11 is absent) in FIGS. 12-15. Bar pin 62 is also illustrated. When the inner elastomeric split ring halves, C-shaped half sleeves and outer elastomeric split ring halves are not in a compressed condition, rounded grooves 114 and 115 are formed, as illustrated in FIG. 15 (and FIG. 12). In addition, with reference to FIG. 14 (and FIG. 12), inner elastomeric split ring half 108 includes end recesses 116a and 116b. Inner elastomeric split ring half 109 features a similar construction. Outer elastomeric split ring half 112 features a plateau portion 118 bordered on opposing edges by ramped portions 120a and 120b. Outer elastomeric split ring half 113 features a similar construction.

When the inner bushing assembly 104 is inserted into sleeve or can 106, as is illustrated in FIGS. 8-11, the inner elastomeric split ring halves 108 and 109, pair of metal C-shaped half sleeves or half cylinders 110 and 111 and outer elastomeric split ring including halves 112 and 113 are radially compressed so that they take on the profiles illustrated in FIGS. 8, 10 and 11.

The C-shaped half sleeves 110 and 111 are preferably formed from steel or metal, but any other material that is at least semi-rigid may be used. The inner elastomeric split ring halves 108 and 109 and outer elastomeric split ring halves 112 and 113 are formed from rubber or any other elastomer. The split ring and C-shaped half sleeve layers are secured together by their inner and/or outer surfaces by adhesive and/or by compressive forces due to placement of the inner bushing assembly within the can 106.

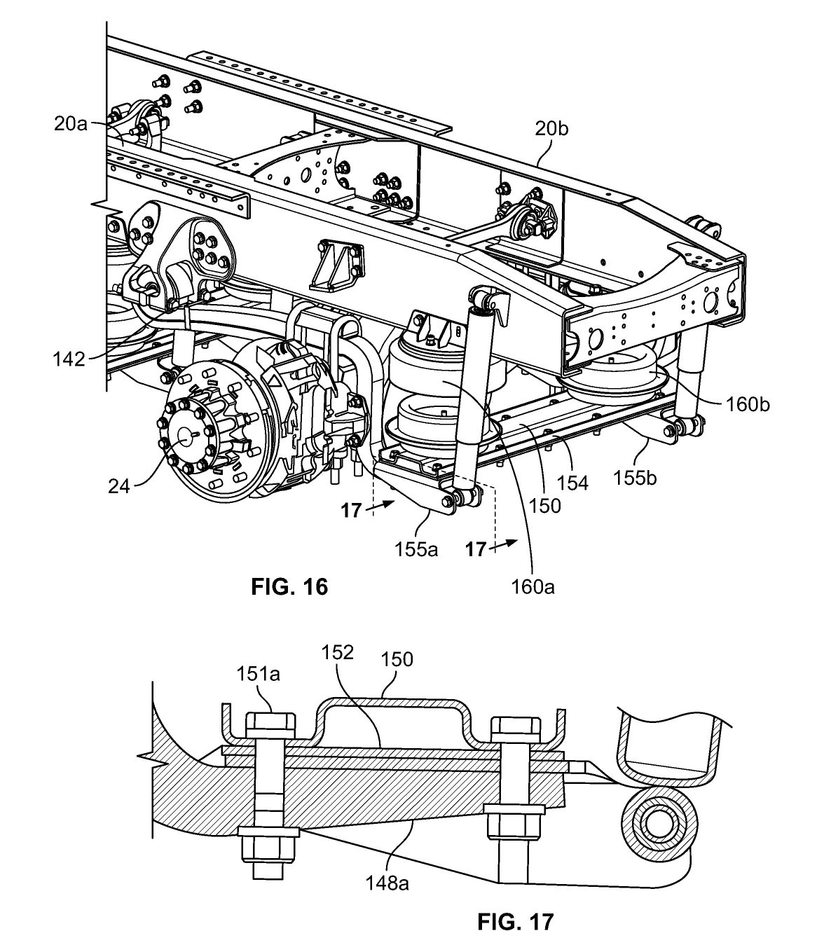

As best shown in FIG. 16, the perimeter of the eye portion of the main support member features a gap 142. The shell 106 (FIGS. 8-11) prevents the outer elastomeric split ring from protruding into or extruding through this gap during use.

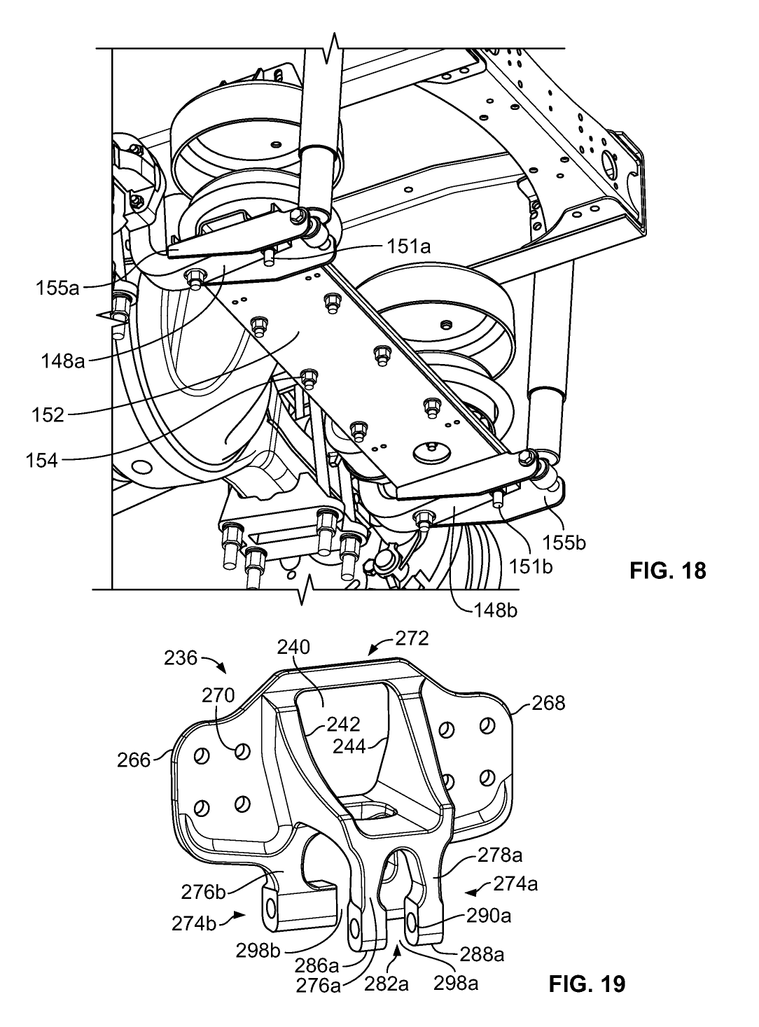

With reference to FIG. 16, axle 24 is secured to frame rails 20a and 20b by main support members having distal end portions 148a and 148b (FIGS. 17 and 18) in the manner described above for main support member 32. A pair of lower shock brackets 155a and 155b are mounted on the distal end portions of the main support members. A cross channel member 150 extends between the distal ends 148a and 148b of the main support members and is bolted to each by bolts 151a and 151b (FIGS. 17 and 18). As best illustrated in FIGS. 17 and 18, a cross channel reinforcement plate 152 abuts the underside of the cross channel member 150 and is sandwiched between the end portions of the cross channel 150 and the distal end portions 148a and 148b of the main support members. In addition to being clamped together by bolts 151a and 151b, the cross channel member 150 and cross channel reinforcement plate 152 are secured together by edge bolts 154 (FIGS. 16 and 18).

As illustrated in FIG. 16, the bottom ends of air springs 160a and 160b are mounted to the cross channel member 150. Cross channel member 150 and cross channel reinforcement plate 152 cooperate to provide a boxed cross sectional area to support the bottoms of the air springs, which increases the load capacity of the suspension and provides a more durable air spring platform. This is provided without the need to weld the structure providing the boxed cross section together.

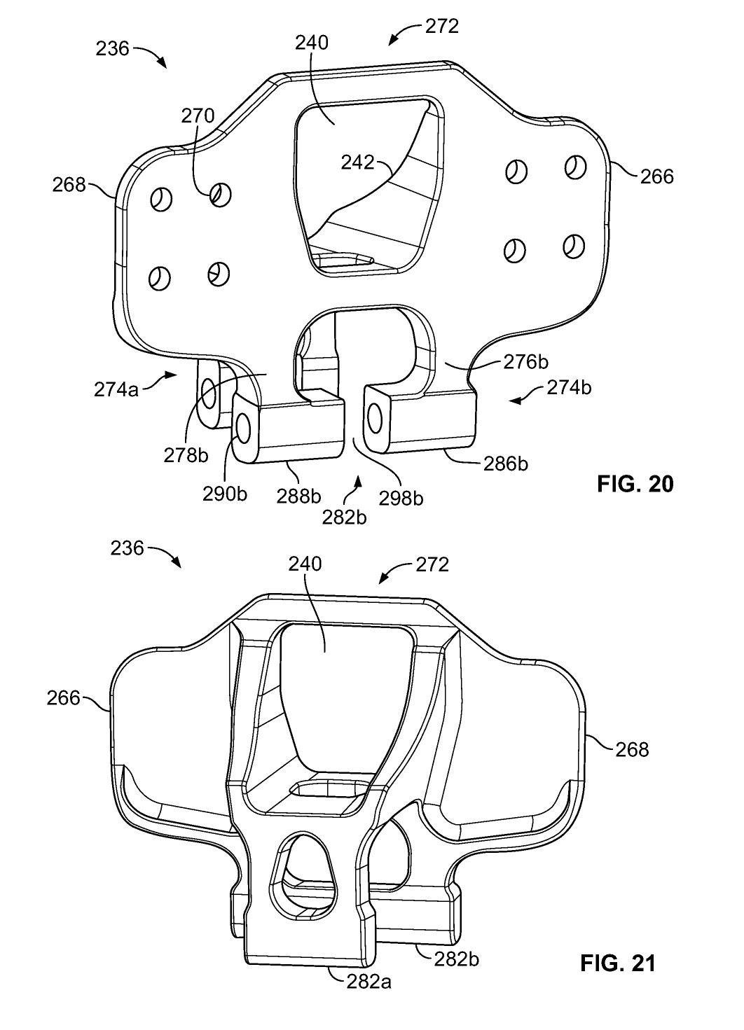

An alternative embodiment of the frame hanger bracket of the disclosure is indicated in general at 236 in FIGS. 19 and 20. Similar to the frame hanger embodiment described above with reference to FIGS. 3-5, the frame hanger bracket 236 of FIGS. 19 and 20 includes a pair of generally flat ear portions 266 and 268 which feature openings 270 through which bolts or other frame fasteners pass to secure the frame hanger bracket to a vehicle frame, in the manner illustrated for frame hanger bracket 36 in FIGS. 3 and 4. A bridge portion, indicated in general at 272, is positioned between the ear portions 266 and 268 and is provided with a pair of horizontally spaced, downward extending flange portions indicated in general at 274a and 274b.

The bridge portion 272 features a bracket opening 240 which accommodates a bracket for mounting accessories to the vehicle frame. The bracket opening is flanked by support webs 242 and 244.

Flange portion 274a is preferably formed by struts 276a and 278a, while flange portion 274b is similarly and preferably formed by struts 276b and 278b. As shown in FIG. 19, an outer bar pin elongated positioning member, indicated in general at 282a, features portions 286a and 288a joined to the distal ends of struts 276a and 278a, respectively. As shown in FIG. 20, an inner bar pin elongated positioning member, indicated in general at 282b, features portions 286b and 288b joined to the distal ends of struts 276b and 278b, respectively. Each elongated positioning member preferably extends in a longitudinal direction parallel to the vehicle frame rails.

The closer positioning (as compared to frame hanger bracket 36 of FIGS. 3-5) of portions 286a and 288a of the outer bar pin positioning member 282a makes the frame hanger bracket 236 of FIGS. 19 and 20 useful in applications where space in the vicinity of the frame hanger bracket is at a premium due to other otherwise interfering vehicle components.

With reference to FIG. 19, portions 286a and 288a of the outer bar pin positioning member 282a feature bores there through (290a in FIG. 19). In use, as illustrated for bar pin positioning member 82a of FIG. 3, a bar pin end is positioned within the gap or space formed between portions 286a and 288a with a bolt (provided with a nut) passing through the bar pin positioning member bores and a corresponding opening in the bar pin end. Of course other fasteners known in the art may be used in place of a nut and bolt as the positioning fastener. One or more shims may be positioned between the bar pin end and the outer bar pin positioning member portion 286a and/or 288a, in the manner indicated for shim 94a in FIG. 3, to align the vehicle axle with the frame.

With reference to FIG. 20, portions 286b and 288b of the bar pin elongated positioning member 282b also feature bores (290b) there through. In use, as illustrated for bar pin positioning member 82b in FIG. 4, a bar pin end is positioned within the gap or space formed between portions 286b and 288b with a bolt (provided with a nut) passing through the bar pin positioning member bores and a corresponding opening in the bar pin end. Of course other fasteners known in the art may be used in place of a nut and bolt as the positioning fastener. As for outer bar pin positioning member 282a, one or more shims may be positioned between the bar pin end and the bar pin elongated positioning member portion 286b and/or 288b to align the vehicle axle with the frame.

In view of the above, the ends of a bar pin are supported on each side by the frame hanger bracket 236 so as to provide a double shear bar pin pivot.

With reference to FIG. 21, frame hanger bracket 236 is preferably cast from ductile iron without openings formed in ear portions 266 and 268 and with bar pin positioning members 282a and 282b formed as a single structure. While ductile iron is easy to cast and machine, it should be noted that any material that is capable of being cast and machined may be used to construct the frame hanger bracket 236. The frame hanger bracket could alternatively be constructed from separate components that are joined together after being formed.

After the casting of FIG. 21 is created, the part is machined to form the frame hanger bracket 236 of FIGS. 19 and 20. More specifically, the positions of the openings 270 on ear portions 266 and 268 of the frame hanger bracket are selected and machined based on the frame hole grid or pattern chosen by the vehicle manufacturer for attaching the frame hanger brackets. This permits the single casting of FIG. 21 to be used with a variety of vehicle frames.

In addition, the bar pin positioning members 282a and 282b of the casting of FIG. 21 are cut so that sections may be removed to form gaps or spaces, illustrated at 298a and 298b in FIGS. 19 and 20, for receiving the ends of the bar pin, or other pivot fastener passing through the main support member eye portion, and alignment adjusting shims (as described above). As described previously with reference to FIGS. 7A and 7B, the location of the spaces 298a and 298b in the bar pin positioning members 282a and 282b may be selected based upon the requirements of the vehicle manufacturer or application. Furthermore, the horizontal width of each gap may be selected based on the degree of axle adjustability desired, i.e., the wider the gap, the more shims that may be added on either side of the bar pin ends. Of course the potential width of gap 298a is more restricted than gap 298b due to the proximity of portions 286a and 288a.

In addition to machining the openings 270 in the ear portions of the frame hanger bracket 236 so that they match a manufacturer's frame hole grid, the location of the overall group of openings 270 on each ear portion may be selected based on the needs of the vehicle or application. For example, the group of openings 270 may be machined more towards the top of the ear portion if the frame hanger bracket is to be positioned lower with respect to the vehicle frame rail, or more towards the bottom of the ear portion if the frame hanger bracket is to be positioned higher with respect to the frame rail. The group of openings also may be shifted forward or rearward on each ear portion. This provides the casting of FIG. 21 with even more flexibility with regard to accommodating various axle position requirements.

The symmetrical design of the casting of FIG. 21 also permits the part to be used on either side of the vehicle.

As described previously, and illustrated in FIG. 2, a shock absorber 52 is pivotally connected by its bottom end to a lower shock bracket 55 positioned on the distal end of the main support member 32. The top end of the shock absorber is pivotally connected to a bracket 54 mounted on the outward facing or outer surface the frame rail 20a. In situations where narrow spacing is required between axles 22 and 24, however, there may be insufficient space on the outer surface of the frame rail for the bracket 54 of the outboard shock absorber mounting arrangement illustrated in FIG. 2. Using an inboard shock absorber mounting configuration, where the top end of the shock absorber is pivotally connected to a bracket mounted on the inward facing or inner surface of the frame rail instead often is not a practical solution as such an arrangement may interfere with the driveline and axle housing.

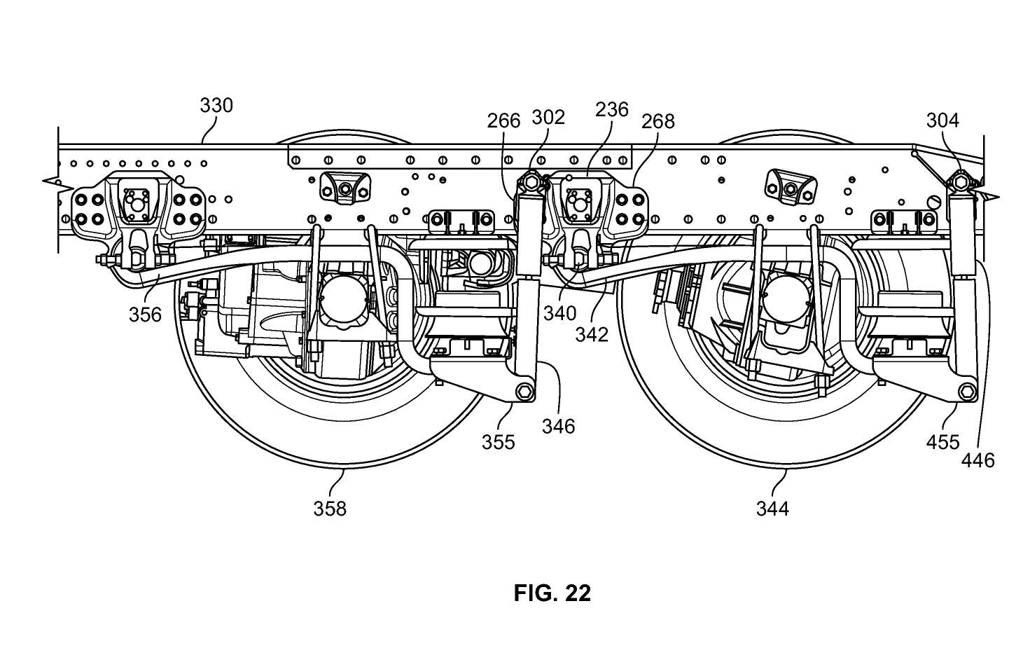

Embodiments of an outboard upper shock mounting bracket that addresses the above issue are illustrated at 302 and 304 in FIG. 22. Notably, as will be explained below, a single casting may be used to quickly and economically produce either the mid bracket 302 or the rear bracket 304 for either side of the vehicle.

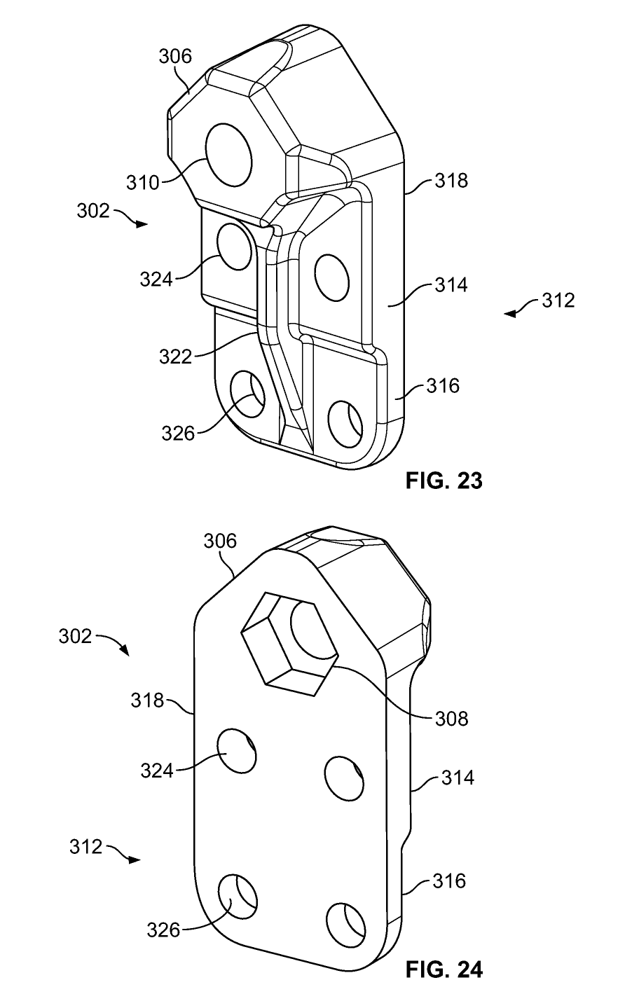

Enlarged front perspective and rear perspective views of the mid bracket (indicated in general at 302) are provided in FIGS. 23 and 24, respectively. As illustrated in FIGS. 23 and 24, the bracket features a head 306 at the distal end portion of the bracket having a hexagonal inner recess 308 and a cylindrical outer bore 310. The inner recess and outer bore are in communication with one another so that the head and a portion of the shaft of a fastener may be positioned therein, as explained in greater detail below.

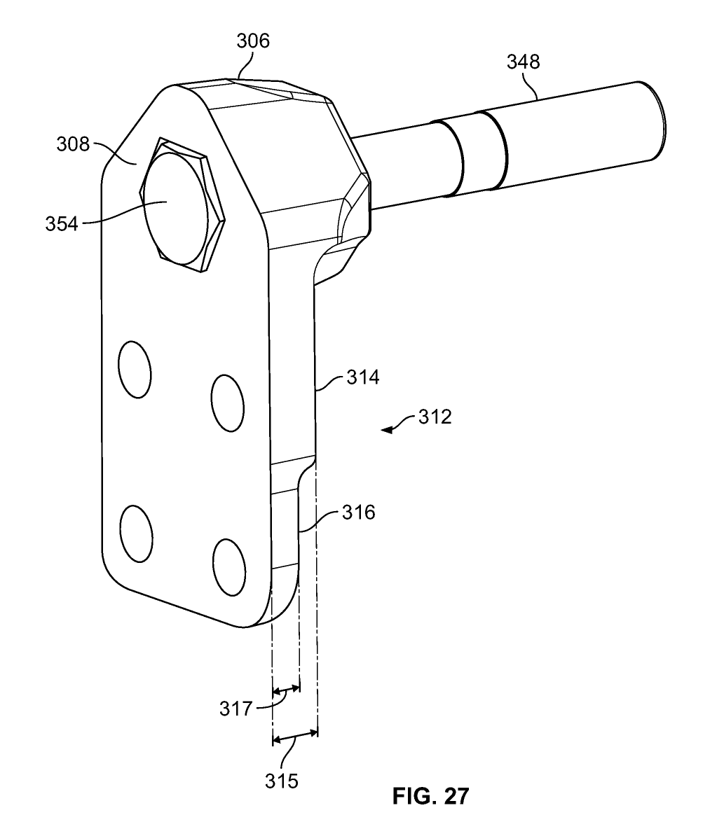

The bracket 302 also features a frame mounting flange, indicated in general at 312, extending from the head 306 that includes a middle portion 314 and a proximal end portion 316. The middle portion 314 has a thickness (illustrated at 315 in FIG. 27) that is greater than the thickness (illustrated at 317 in FIG. 27) of the proximal end portion 316 so that the outer surface (facing outward away from the vehicle frame when mounted) of the bracket features a stair step profile. The head 306 protrudes beyond the outer surface of the middle portion of the mounting flange in a direction perpendicular to the outer surface of the flange middle portion (and the proximal end portion). The inner surface 318 (facing inward towards the vehicle frame) features a flat profile. The mounting flange also includes a central fin 322. Mounting apertures 324 are formed on opposite sides of the central fin in the middle portion 314 of the mounting flange. Likewise, mounting apertures 326 are formed on opposite sides of the central fin in the proximal end portion 316 of the mounting flange.

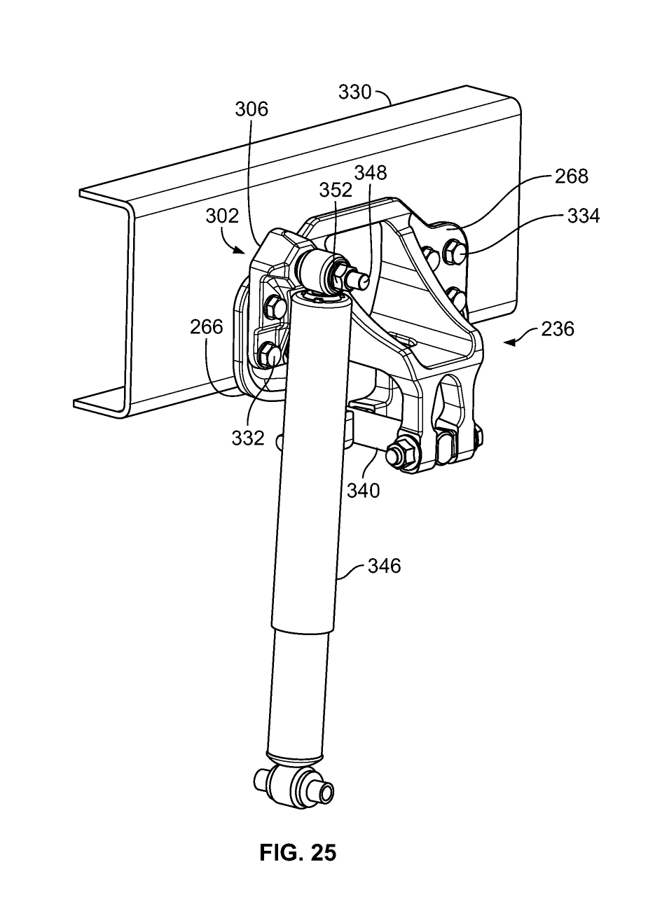

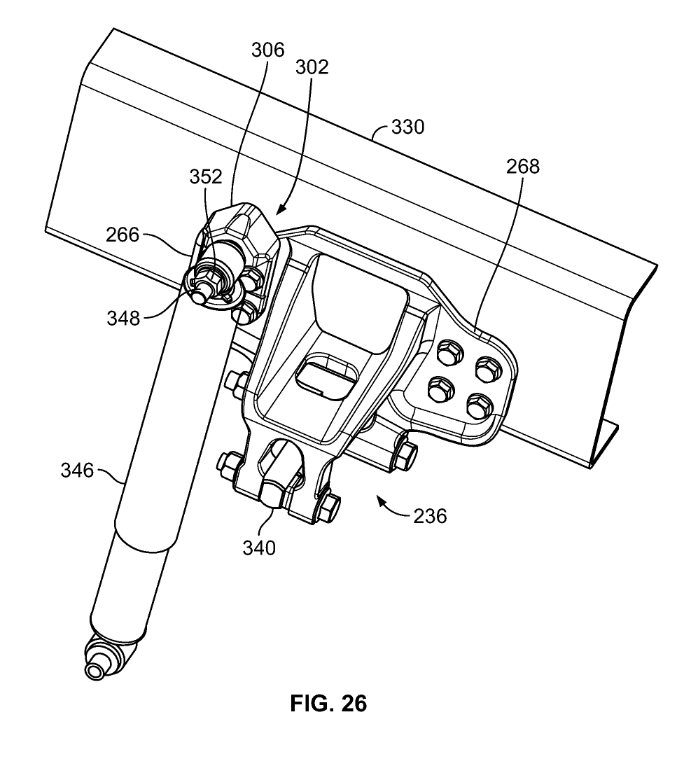

The frame hanger bracket 236, described above with reference to FIGS. 19-21, is shown mounted to a vehicle frame rail 330 in FIGS. 25 and 26. More specifically, as described previously, the frame hanger bracket 236 includes a pair of generally flat ear portions 266 and 268 through which bolts 332 and 334 pass to secure the frame hanger bracket to the vehicle frame. The ends of a bar pin 340 are supported by the frame hanger bracket 236 in the manner described previously so as to provide a double shear bar pin pivot. With reference to FIG. 22, the bar pin 340 pivotally supports the proximal end of a main support member 342 to which the rear axle 344 is mounted.

As illustrated in FIGS. 25 and 26 (and FIG. 22), the mid bracket 302 is mounted to the vehicle frame rail using the same mounting bolts 332 as the ear portion 266 of the frame hanger bracket 236. These mounting bolts pass through the mounting apertures 324 and 326 (FIGS. 23 and 24) of the mid bracket 302. As a result, the mid bracket overlays a portion of the outer surface of the hanger bracket ear portion 266 so that the ear portion is sandwiched between the mid bracket 302 and the frame rail 330. Fasteners other than the mounting bolts 332 may be used.

The top end of shock absorber 346 is pivotally mounted to the head 306 of the mid bracket 302 by a fastener including a bolt having a threaded shaft 348 which is received by a threaded bore of nut 352. As illustrated in FIG. 27, the head 354 of the bolt is positioned within the hexagonal inner recess 308 of the head 306 of the mid bracket so that the threaded shaft 348 of the bolt extends through the outer bore 310. Of course other fasteners known in the art may be used in place of the illustrated nut and bolt arrangement.

As illustrated in FIG. 22, the bottom end of shock absorber 346 is pivotally secured to a lower shock bracket 355 positioned on the trailing end of the main support member 356 to which axle 358 is mounted.

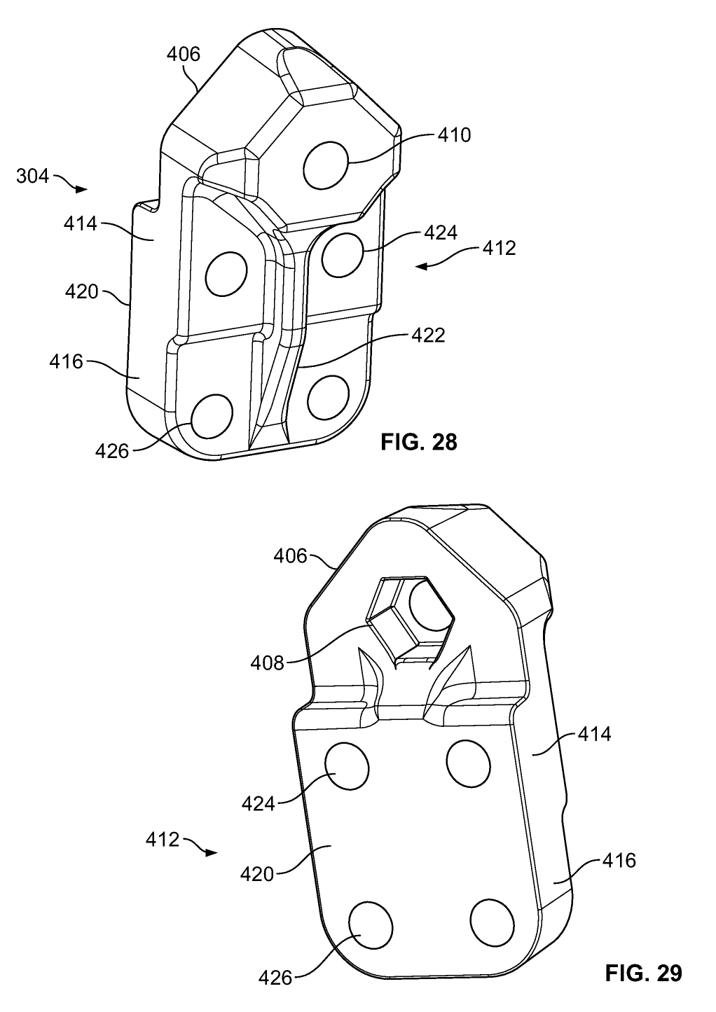

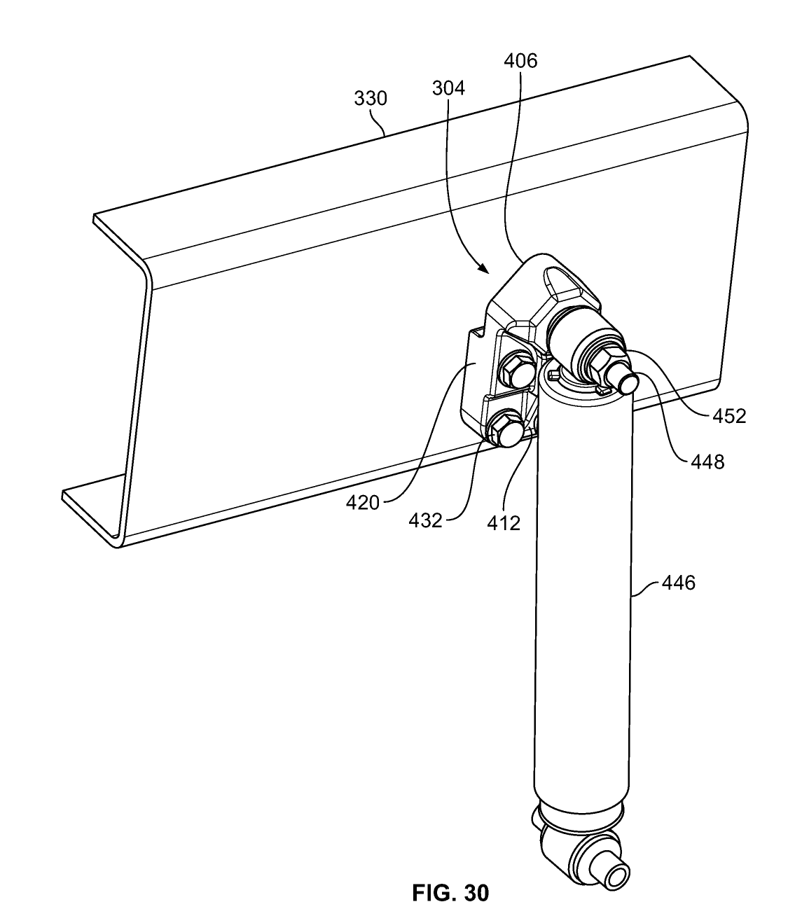

Enlarged front perspective and rear perspective views of the rear bracket (indicated in general at 304) are provided in FIGS. 28 and 29, respectively. As illustrated in FIGS. 28 and 29, the bracket features a head 406 at the distal end portion of the bracket having a hexagonal inner recess 408 and a cylindrical outer bore 410 that are in communication with one another.

The bracket 304 also features a frame mounting flange, indicated in general at 412 in FIGS. 28 and 29, extending from the head 406 that includes a middle portion 414 and a proximal end portion 416. The middle portion 414 has a thickness that is greater than the proximal end portion 416 so that the outer surface (facing outward away from the vehicle frame when mounted) of the bracket features a stair step profile. The head 406 protrudes beyond the outer surface of the middle portion of the mounting flange in a direction perpendicular to the outer surface of the flange middle portion (and the proximal end portion).

Unlike the mid bracket 302 of FIGS. 23 and 24, the inner surface (facing inward towards the vehicle frame) of the rear bracket features a protruding backing portion 420 to properly position the top end of the shock absorber, as will be explained below.

The mounting flange also includes a central fin 422. Mounting apertures 424 are formed on opposite sides of the central fin in the middle portion 414 of the mounting flange. Likewise, mounting apertures 426 are formed on opposite sides of the central fin in the proximal end portion 416 of the mounting flange.

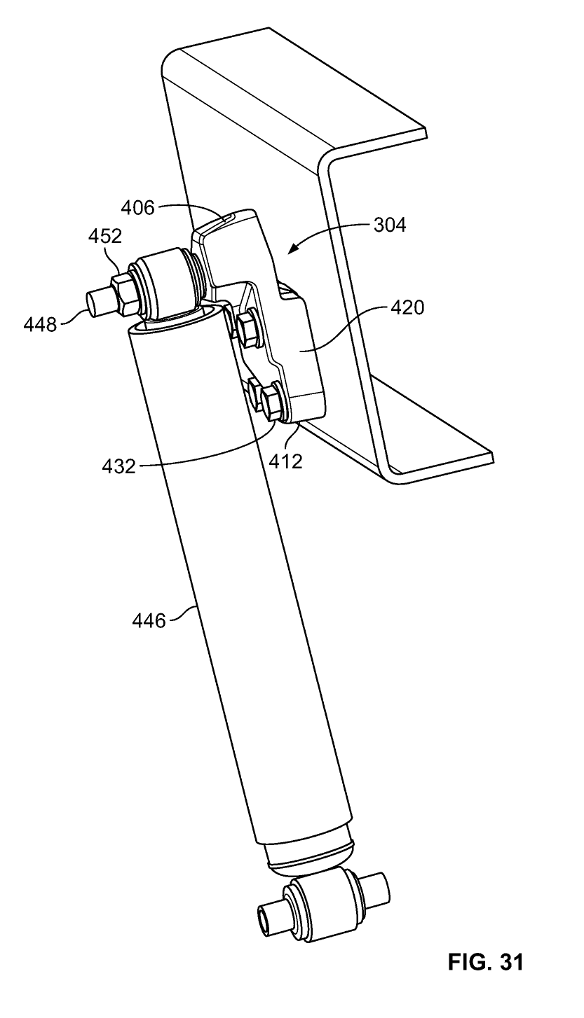

The rear bracket 304 is shown mounted to a vehicle frame 330 in FIGS. 30 and 31 (and FIG. 22). The rear bracket 304 is mounted to the vehicle frame rail using mounting bolts 432. These mounting bolts pass through the mounting apertures 424 and 426 (FIGS. 28 and 29) of the mid bracket 304. Of course fasteners other than bolts 432 may be used.

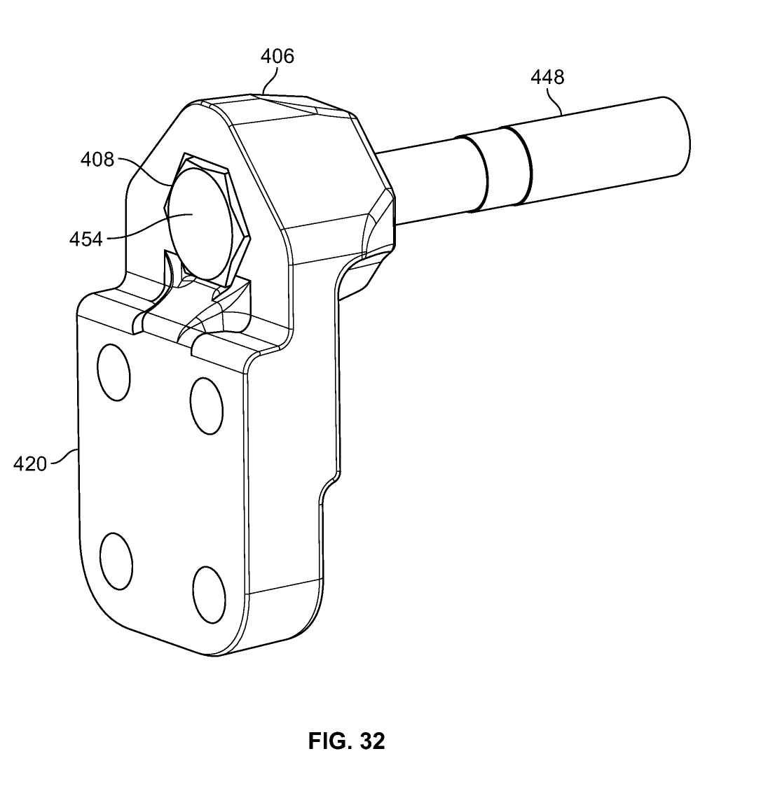

The top end of shock absorber 446 is pivotally mounted to the head 406 of the mid bracket 304 by a fastener including a bolt having a threaded shaft 448 which is received by a threaded bore of nut 452. As illustrated in FIG. 32, the head 454 of the bolt is positioned within the hexagonal inner recess 408 of the head 406 of the rear bracket so that the threaded shaft 448 of the bolt extends through the outer bore 410. Of course other fasteners known in the art may be used in place of the illustrated nut and bolt arrangement.

As illustrated in FIG. 22, the bottom end of shock absorber 446 of is pivotally secured to a lower shock bracket 455 positioned on the trailing end of the main support member 342 to which axle 344 is mounted.

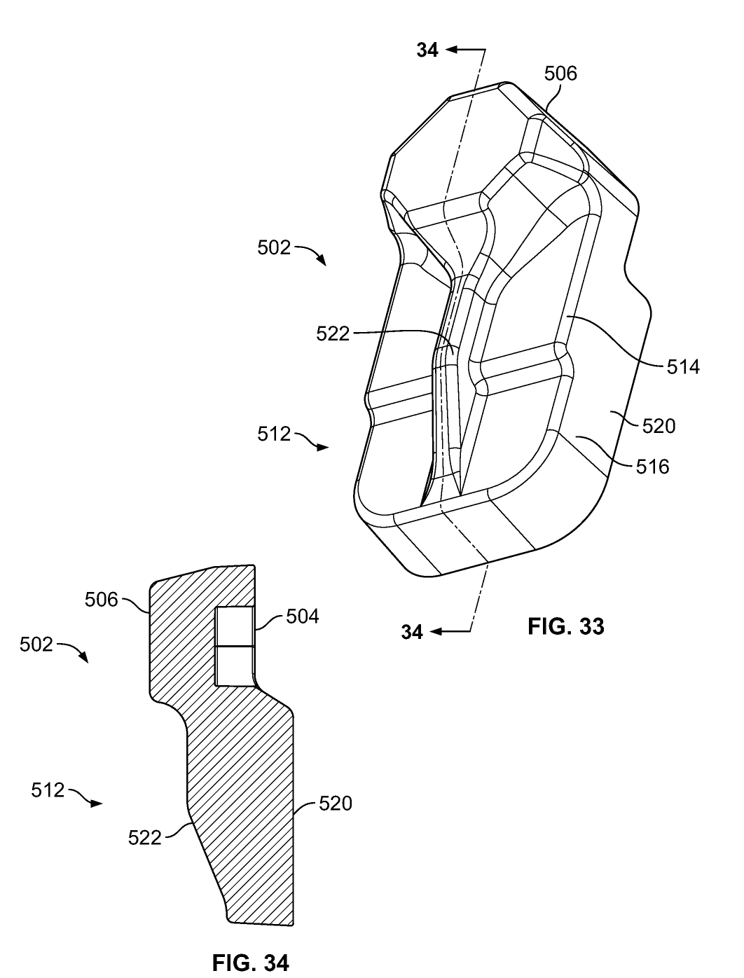

With reference to FIGS. 33 and 34, a casting, indicated in general at 502, may be used to form either one of the outboard upper shock brackets 302 and 304. The part 502 is preferably cast from ductile iron without openings formed, other than the hexagonal recess 504 formed in the inner surface of the head 506 of the casting. Recess 504 corresponds to either recess 308 (FIG. 24) or recess 408 (FIG. 29). While ductile iron is easy to cast and machine, it should be noted that any material that is capable of being cast and machined may be used to construct the casting. The casting could alternatively be constructed from separate components that are joined together after being formed.

As with the mid and rear brackets described above, the casting 502 also features a frame mounting flange, indicated in general at 512, extending from the head 506 that includes a middle portion 514 and a proximal end portion 516. The middle portion 514 has a thickness that is greater than the thickness of the proximal end portion 516 so that the outer surface (facing outward away from the vehicle frame when mounted) of the bracket features a stair step profile. The head 506 protrudes beyond the outer surface of the middle portion of the mounting flange in a direction perpendicular to the outer surface of the flange middle portion (and the proximal end portion). The mounting flange also includes a central fin 522 positioned on the outer surface which traverses the outer surfaces of middle and proximal end portions 514 and 516.

The inner surface (facing inward towards the vehicle frame) of casting 502 features a protruding backing portion 520

After the casting of FIGS. 33 and 34 is created, the part is machined to form either the mid bracket 302 of FIGS. 22-27, or the rear bracket 304 of FIGS. 28-32. If the casting is being used to make the rear bracket 304, the protruding backing portion 520, which corresponds to backing portion 420 of FIGS. 29-32, is retained. If the casting is being used to construct the mid bracket 302 (FIGS. 22-27), however, the backing portion 520 is machined off so that the flat inner surface 318 (FIGS. 23 and 24) of the bracket is formed.

As illustrated in FIGS. 25 and 26 in comparison with FIGS. 30 and 31, the presence or absence of the backing portion 506 of the casting permits the upper end of shock absorbers 346 and 446 to be properly positioned by the mid bracket 302 and rear bracket 304, respectively. More specifically, as illustrated in FIGS. 25 and 26, a gap exists between the inner surface of the head portion 306 and the outer surface of frame rail 330 due to the frame hanger bracket 236 being sandwiched between the mid bracket 302 and the frame. In contrast, with reference to FIGS. 30 and 31, a frame hanger bracket is not positioned between the rear bracket 304 and the frame rail 330. The protruding backing portion 420 of the rear bracket 304 takes the place of the frame hanger bracket so that a gap is also provided between the inner surface of rear bracket head 408 and the outer surface of the frame rail 330. As a result, the upper ends of shock absorbers 346 and 446 are mounted the same distance from the outer surface of the frame rail 330.

The casting 502 (FIGS. 33 and 34) is also machined to provide the openings 310, 324 and 326 of mid bracket 302 of FIGS. 23 and 24 or the openings 410, 424 and 426 of the rear bracket 304 of FIGS. 28 and 29. The positions of the openings 324 and 326 of the mid bracket (FIGS. 23 and 24) or the positions of the openings 424 and 426 (FIGS. 28 and 29) of the rear bracket are selected and machined based on the frame hole grid or pattern chosen by the vehicle manufacturer for attaching the frame hanger bracket (for the mid bracket) or the upper shock mounting bracket (for the rear bracket). This permits the single casting 502 of FIGS. 33 and 34 to be used with a variety of vehicle frames. In addition, the symmetrical design of the casting 502 of FIGS. 33 and 34 permits it to be used on either side of the vehicle.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A frame hanger bracket for pivotally mounting a suspension main support member to a vehicle frame comprising;
a. a pair of ear portions adapted to be attached to the vehicle frame;
b. a bridge portion positioned between the pair of ear portions;
c. a pair of flanges extending from the bridge portion so that a space is defined therebetween, said space adapted to receive a proximal end of the main support member; and
d. each of said pair of flanges including an elongated positioning member including a space adapted to receive an end portion of a pivot fastener attached to the main support member so that a double shear connection is formed with the pivot fastener.

2. The frame hanger bracket of claim 1 wherein each of the pair of flanges includes first and second struts attached by their proximal ends to the bridge portion and by their distal ends to the elongated positioning member.

3. The frame hanger of claim 2 wherein the first and second struts and elongated positioning member form a stirrup shape.

4. The frame hanger bracket of claim 1 wherein the elongated positioning member includes a bore adapted to receive a positioning fastener for engaging an end of the pivot fastener.

5. The frame hanger bracket of claim 1 wherein the pair of ear portions, bridge portion and pair of flanges are integrally formed as a casting.

6. The frame hanger bracket of claim 1 wherein the bridge portion is formed by a hollow protrusion.

7. The frame hanger bracket of claim 1 wherein the bridge portion includes a bracket opening.

8. The frame hanger bracket of claim 1 wherein each of the ear portions include openings adapted to receive frame fasteners for attaching the frame hanger bracket to the vehicle frame;

9. The frame hanger bracket of claim 1 wherein the elongated positioning member extends in a longitudinal direction.

10. A frame hanger assembly for pivotally mounting a suspension main support member having an eye portion on a proximal end to a vehicle frame comprising;
a. a frame hanger bracket including:
i) a pair of ear portions adapted to be fastened to the vehicle frame,
ii) a bridge portion positioned between the pair of ear portions;
iii) a pair of flanges extending from the bridge portion so that a space is defined therebetween said space adapted to receive the proximal end of the main support member;
iv) each of said pair of flanges including a positioning member including a gap;
b. a bushing positioned within the eye portion of the main support member, said bushing including a central opening;
c. a pivot fastener passing through the central opening of the bushing and having a pair of opposite end portions positioned within the gaps of the positioning members of the pair of flanges so that a double shear connection is formed with the pivot fastener.

11. The frame hanger assembly of claim 10 wherein each of the pair of flanges Includes first and second struts attached by their proximal ends to the bridge portion and by their distal ends to the positioning member.

12. The frame hanger assembly of claim 11 wherein the first and second struts and positioning member form a stirrup shape.

13. The frame hanger assembly of claim 10 wherein the pivot fastener is a bar pin.

14. The frame hanger assembly of claim 13 wherein the positioning member includes a bore adapted to receive a bolt for engaging an end of the pivot fastener.

15. The frame hanger assembly of claim 10 wherein the bushing includes an inner bushing assembly positioned within a shell, said inner bushing assembly including an inner elastomeric split ring, a pair of C-shaped half sleeves generally surrounding the inner elastomeric split ring and an outer elastomeric split ring generally surrounding the pair of C-shaped half sleeves.

16. A suspension for a vehicle having a pair of frame rails comprising on each side of the vehicle;
a. a main support member including an eye portion positioned on a proximal end;
b. a frame hanger bracket including:
i) a pair of ear portions adapted to be fastened to a corresponding one of the pair of vehicle frame rails,
ii) a bridge portion positioned between the pair of ear portions;
iii) a pair of flanges extending from the bridge portion so that a space is defined therebetween, said space receiving the proximal end of the main support member;
iv) each of said pair of flanges including a positioning member including a gap;
c. a bushing positioned within the eye portion of the main support member, said bushing including a central opening;
d. a pivot fastener passing through the central opening of the bushing and having a pair of opposite end portions positioned within the gaps of the positioning members of the pair of flanges so that a double shear connection is formed with the pivot fastener.

17. The suspension of claim 16 further comprising:
e. a cross channel member extending between and fastened to distal ends of the main support members on each side of the vehicle;
f. a cross channel reinforcement plate extending between and fastened to the distal ends of the main support members and the cross channel member, said cross channel reinforcement plate abutting a surface of the cross channel member so that a box cross section is formed;
g. a pair of air springs positioned between and fastened to the cross channel member and the pair of vehicle frame rails.

18. A casting for forming a frame hanger bracket for pivotally mounting a suspension main support member to a vehicle frame comprising;
a. a pair of ear portions adapted to have openings formed therein for attachment to the vehicle frame;
b. a bridge portion positioned between the pair of ear portions;
c. a pair of flanges extending from the bridge portion so that a space is defined therebetween, said space adapted to receive a proximal end of the main support member; and
d. each of said pair of flanges including a positioning member adapted to be cut to form a space for receiving an end portion of a pivot fastener attached to the main support member so that a double shear connection is formed with the pivot fastener.

19. The casting of claim 18 wherein the bridge portion is formed by a hollow protrusion.

20. The casting of claim 18 wherein the bridge portion includes a bracket opening.

21. A shock bracket for mounting an upper end of a shock absorber to a vehicle frame comprising;
a. a head adapted to be secured to the upper end of the shock absorber; and
b. a mounting flange extending from the head, said mounting flange adapted to be secured to the vehicle frame so that an inner surface of the head is spaced from the vehicle frame when the shock bracket is mounted to the vehicle frame.

22. The shock bracket of claim 21 wherein the bracket includes a generally flat inner surface so that the head is spaced from the vehicle frame when the bracket is mounted to the vehicle frame with a second bracket positioned between the inner surface of the mounting flange and an outer surface of the vehicle frame.

23. The shock bracket of claim 21 wherein the mounting flange includes a backing portion that protrudes from an inward side of the shock bracket and that engages an outer surface of the vehicle frame when the shock bracket is mounted to the vehicle frame.

24. The shock bracket of claim 1 wherein the head includes an inner recess adapted to
receive a head of a fastener and an outer bore in communication with the inner recess and adapted to receive a shaft of the fastener.

25. The shock bracket of claim 1 wherein the mounting flange includes a middle portion and a proximal end portion, where the middle portion has a thickness greater than the proximal end portion so that an outer surface of the flange features a stair step profile.

26. The shock bracket of claim 25 wherein the middle portion of the mounting flange includes a first pair of mounting apertures and the proximal portion includes a second pair of mounting apertures.

27. The shock bracket of claim 26 wherein a fin is positioned on the outer surface of the mounting flange and passes between the apertures of the first pair of mounting apertures and the apertures of the second pair of mounting apertures.

28. A suspension for a vehicle having a pair of frame rails comprising on each side of the vehicle;
a. a main support member including a proximal end and a distal end with an eye portion positioned on a proximal end;
b. a frame hanger bracket featuring an ear portion adapted to be mounted to an outer surface of a frame rail of the vehicle;
c. a pivot fastener passing through the eye portion of the main support member and having a pair of opposite end portions secured within the frame hanger bracket;
d. a shock bracket including a head and a mounting flange, said mounting flange adapted to be mounted to the frame rail of the vehicle with the ear portion of the frame hanger sandwiched between the shock bracket mounting flange and the outer surface of the vehicle frame rail; and
e. a shock absorber having an upper end pivotally connected to the head of the shock bracket and a lower end pivotally connected to the distal end of the main support member.

29. A casting for forming a shock bracket for pivotally mounting an upper end of a shock absorber to a vehicle frame comprising;
a. a head having an inner surface and an outer surface and adapted to have an opening formed therein for attachment to the upper end of the shock absorber;
b. a mounting flange extending from the head and including;
i) a middle portion having a first thickness;
ii) a proximal end portion having a second thickness, where the first thickness is greater than the second thickness so that the mounting flange has an outer surface with a stair step profile;
iii) a backing portion protruding beyond the inner surface of the head in a direction perpendicular to the inner surface of the head.

30. The casting of claim 29 wherein the inner surface of the head includes a recess adapted to receive a head of a fastener.

31. The casting of claim 29 further comprising a fin positioned on the outer surface of the flange and traversing the middle and proximal end portions of the mounting flange.

32. The casting of claim 29 wherein the head has an outer surface that protrudes beyond the outer surface of the mounting flange in a direction perpendicular to the outer surface of the mounting flange.
